(19) United States
(12) Patent Application Publication
(10) Pub. No.: US 2026/0002472 A1
(43) Pub. Date: Jan. 1, 2026

(54) GAS TURBINE ENGINE WITH HEAT EXCHANGER

(71) Applicants: General Electric Company, Schenectady, NY (US); General Electric Deutschland Holding GmbH, Frankfurt (DE)

(72) Inventors: Hojjat Nasr, West Chester, OH (US); Ashish Sharma, Muenchen (DE); Michael Vadnais, Delafield, WI (US); Kevin Edward Hinderliter, Loveland, OH (US); Jonathan Russell Ratzlaff, Loveland, OH (US)

(21) Appl. No.: 18/756,318

(22) Filed: Jun. 27, 2024

(51) Int. Cl. F02C 7/14; F28D 15/04

(52) U.S. Cl. CPC F02C 7/14; F28D 15/043; F05D 2260/208

(57) ABSTRACT

A heat exchanger for a gas turbine engine includes an inlet manifold, an outlet manifold, a plate extending from the inlet manifold to the outlet manifold, and a heat pipe in thermal communication with the plate. The heat pipe includes a pipe defining a cavity and a fluid disposed in the cavity.

### FIELD

The present disclosure relates to gas turbine engines, specifically heat exchangers for gas turbine engines.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited, generating hot combustion gases. The combustion gases are channeled to the turbines which extracts energy from the combustion gases for powering the compressors, as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is schematic view of an exemplary gas turbine engine.

FIG. 2 is a cross-sectional view of a fan section of the exemplary gas turbine engine of FIG. 1.

FIG. 3 is a cross-sectional view of an exemplary heat pipe.

FIG. 4 is a cross-sectional view of another exemplary heat pipe.

FIG. 5 is a schematic view of an exemplary heat exchanger with a heat pipe.

FIG. 6 is a schematic view of another exemplary heat exchanger with a heat pipe.

FIG. 7 is a schematic view of another exemplary heat exchanger with a heat pipe.

FIG. 8 is a schematic view of another exemplary heat exchanger with a heat pipe.

FIG. 9 is a cross-sectional view of an exemplary heat exchanger with heat pipes.

FIG. 10 is a cross-sectional view of another exemplary heat exchanger with heat pipes.

FIG. 11 is a schematic view of another exemplary heat exchanger with heat pipes.

FIG. 12 is a cross-sectional view of the heat exchanger of FIG. 11 along the line 12-12.

FIG. 13 is a schematic view of an exemplary heat exchanger with a plurality of heat pipes.

FIG. 14 is a schematic view of an exemplary heat exchanger with a bypass line.

FIG. 15 is a schematic view of an exemplary heat exchanger with a bypass plate.

FIG. 16A is a side view of an exemplary heat exchanger assembly.

FIG. 16B is a rear view of the exemplary heat exchanger assembly of FIG. 16A in the direction of the line B-B.

FIG. 17 is a magnified view of an exemplary heat exchanger with a plurality of heat pipes.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The phrases “from X to Y” and “between X and Y” each refers to a range of values inclusive of the endpoints (i.e., refers to a range of values that includes both X and Y).

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

Aviation engines use fluids, such as oil or fuel, to dissipate heat from engine components, such as engine bearings, electrical generators, and the like. Heat is typically rejected from the fluid to air by heat exchangers, such as oil cooled oil cooler or air cooled surface oil coolers, to maintain oil temperatures at a desired 100° F.<T<300° F. In many instances an environment in which the engine may be operated may be as low as −65° F. When the engine is in an engine shut down occurrence in a low temperature environment, the oil within the heat exchanger begins to cool and may become very viscous, i.e., the oil “congeals.” As a result, due to the high viscosity of the oil, it does not flow through the heat exchanger and requires a lengthy period of time to heat up the oil to a desired viscosity for flowing through the heat exchanger. Heating the oil to a desired viscosity is also referred to as “decongealing” the oil, i.e., reversing the congealing of the oil and returning the oil to a more fluid state.

To decongeal the oil, the heat exchanger of the present disclosure includes a heat pipe that transfers heat to a portion of the heat exchanger with congealed oil. More specifically, the heat pipe includes a fluid that is heated by a heat source, such as a hot portion of the heat exchanger. The heated fluid in the heat pipe heats the portion of the heat exchanger with congealed oil, decongealing the oil. The heat pipe is in thermal communication with the portion of the heat exchanger with congealed oil, such as by physical contact to conduct the heat. Using heat pipes addresses space constraints in the gas turbine engine and reduces a total number of components in the heat exchanger.

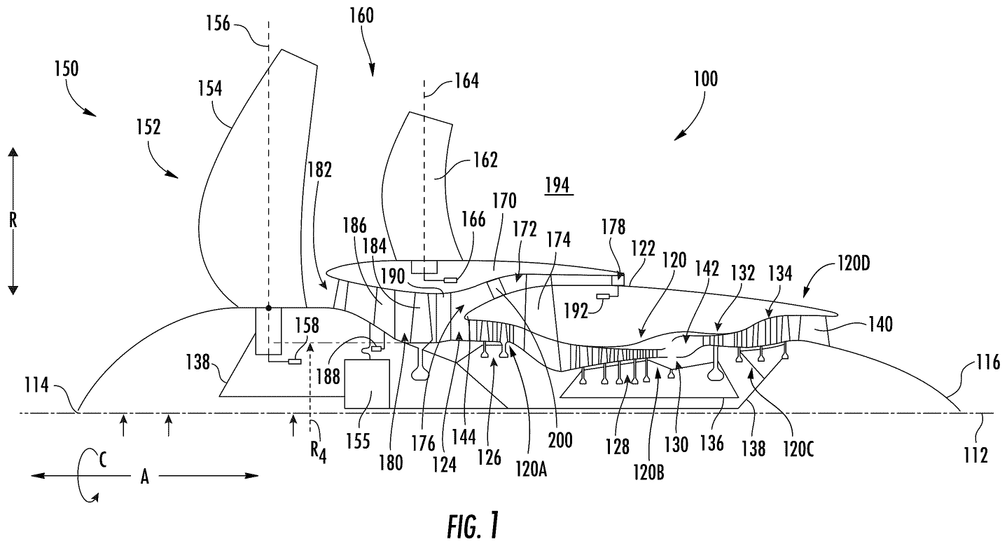

Referring now to the drawings, wherein identical numerals indicate the same elements throughout the figures, Referring now to FIG. 1, a schematic cross-sectional view of an engine 100 (e.g., a gas turbine engine) is provided according to an example embodiment of the present disclosure. Particularly, FIG. 1 provides a turbofan engine having a rotor assembly with a single stage of unducted rotor blades. In such a manner, the rotor assembly may be referred to herein as an “unducted fan,” or the entire engine 100 may be referred to as an “unducted turbofan engine.” In addition, the engine 100 of FIG. 1 includes a third stream extending from the compressor section to a rotor assembly flowpath over the turbomachine, as will be explained in more detail below.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

The engine 100 includes a turbomachine 120 and a rotor assembly, also referred to a fan section 150, positioned upstream thereof. Generally, the turbomachine 120 includes, in serial flow order, a compressor section 120A, a combustion section 120B, a turbine section 120C, and an exhaust section 120D. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section 120B where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. As will be appreciated, the high pressure compressor 128, the combustor 130, and the high pressure turbine 132 may collectively be referred to as the “core” of the engine 100. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. In such a manner, the engine 100 may be referred to as an open rotor engine.

As depicted, the fan 152 includes an array of fan blades 154 (only one shown in FIG. 1). The fan blades 154 are rotatable, e.g., about the longitudinal axis 112. As noted above, the fan 152 is drivingly coupled with the low pressure turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. As will be appreciated, a distance from the base of each fan blade 154 to a tip of the respective fan blade 154 is referred to as a span of the respective fan blade 154.

Moreover, each fan blade 154 defines a central blade axis 156. For this embodiment, each fan blade 154 of the fan 152 is rotatable about their respective central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section 120B for the embodiment depicted). The ducted fan 184 is rotatable about the same axis (e.g., the longitudinal axis 112) as the fan blade 154. The ducted fan 184 is, for the embodiment depicted, driven by the low pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween. As will be appreciated, a distance from the base of each fan blade of the ducted fan 184 to a tip of the respective fan blade is referred to as a span of the respective fan blade.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. The inlet duct 180 is wider than the core duct 142 along the radial direction R. The inlet duct 180 is also wider than the fan duct 172 along the radial direction R. The ducted fan 184 is positioned at least partially in the inlet duct 180. Airflow from the fan 152 is split between a bypass passage 194 and the inlet duct 180. Airflow from the ducted fan 184 is split between the fan duct 172 and the core duct 142 by the leading edge 144.

Notably, for the embodiment depicted, the engine 100 includes one or more features to increase an efficiency of a third stream thrust, Fn_{3S} (e.g., a thrust generated by an airflow through the fan duct 172 exiting through the fan exhaust nozzle 178, generated at least in part by the ducted fan 184). In particular, the engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the engine 100 may be capable of generating more efficient third stream thrust, Fn_{3S}, across a relatively wide array of engine operating conditions, including takeoff and climb (where a maximum total engine thrust Fn_{Total}, is generally needed) as well as cruise (where a lesser amount of total engine thrust, Fn_{Total}, is generally needed).

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 200 may be positioned in thermal communication with the fan duct 172. For example, one or more heat exchangers 200 may be disposed within the fan duct 172 and utilized to cool one or more fluids from the core engine with the air passing through the fan duct 172, as a resource for removing heat from a fluid, e.g., compressor bleed air, oil or fuel.

As further described below, the heat exchanger 200 may be an annular heat exchanger extending substantially 360 degrees in the fan duct 172 (e.g., at least 300 degrees, such as at least 330 degrees). In such a manner, the heat exchanger 200 may effectively utilize the air passing through the fan duct 172 to cool one or more systems of the engine 100 (e.g., lubrication oil systems, compressor bleed air, electrical components, etc.). The heat exchanger 200 uses the air passing through the fan duct 172 as a heat sink and correspondingly increases the temperature of the air downstream of the heat exchanger 200 and exiting the fan exhaust nozzle 178.

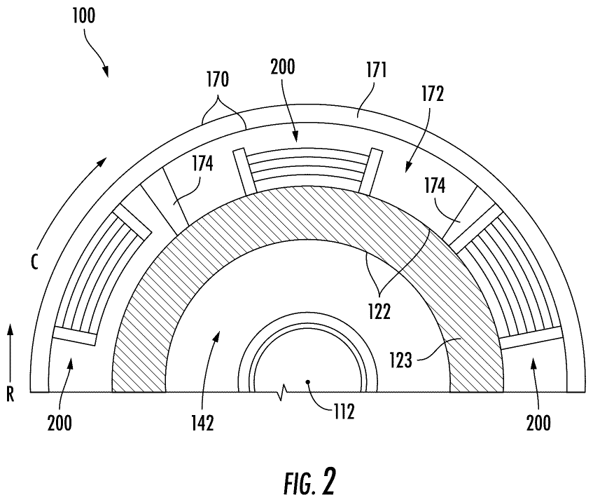

Referring now to FIG. 2, a cross-sectional view of the engine 100 is shown with one or more heat exchangers 200 supported therein. The heat exchangers 200 are circumferentially arranged within the fan duct 172 and circumferentially spaced from each other. The heat exchangers 200 may be coupled to the engine 100 in a variety of ways. As an example, as shown, the heat exchangers 200 may be coupled to the fan cowl 170 (e.g. coupled only to the fan cowl 170 in some embodiments), such that the heat exchanger 200 is secured within the fan duct 172 by the fan cowl 170. In many embodiments, the heat exchanger 200 may extend at least partially through the fan cowl 170 and coupled directly to a supporting structure 171 (e.g. only to the supporting structure 171 in some embodiments), which is housed within the fan cowl 170, such that the heat exchanger 200 is secured within the fan duct 172 by the supporting structure 171.

In other embodiments, the heat exchanger 200 may be coupled to the core cowl 122 (e.g. coupled only to the core cowl 122 in some embodiments), such that the heat exchanger 200 is secured to within the fan duct 172 by the core cowl 122. In many embodiments, the heat exchanger 200 may extend at least partially through the core cowl 122 and couple directly to a supporting structure 123 (e.g. only to the supporting structure 123 in some embodiments), which is housed within the core cowl 122, such that the heat exchanger 200 is secured within the fan duct 172 by the supporting structure 123.

In yet still further embodiments, the heat exchanger 200 may be coupled to one or more of the stationary struts 174 (e.g. only to the stationary strut(s) 174 in some embodiments), such that the heat exchanger 200 may be secured within the fan duct by the stationary strut(s) 174. In yet still further embodiments, one or more of the heat exchangers 200 may be coupled to any combination of the fan duct 172, the supporting structure 171, the core cowl 122, the supporting structure 123, and the one or more stationary struts 174.

In particular embodiments, as described above, each of the heat exchangers 200 may be coupled to a different structure within the fan duct 172 of the engine 100. For example, as shown, a first heat exchanger 200 may be coupled to the fan cowl 170, a second heat exchanger 200 may be coupled to the core cowl 122, and a third heat exchanger 200 may be coupled to the stationary strut 174.

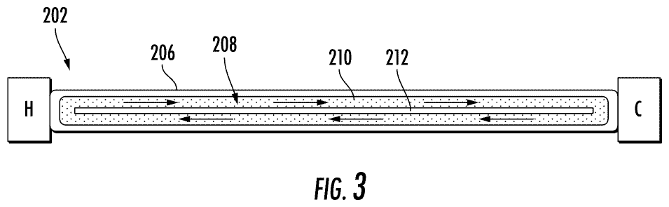

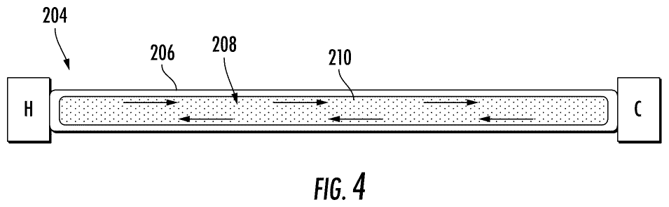

Referring now to FIGS. 3-4, exemplary heat pipes of the heat exchanger 200 are shown. FIG. 3 is a cross-sectional view of a heat pipe 202 that includes a wick. FIG. 4 is a cross-sectional view of a heat pipe 204 that does not include a wick.

As shown in FIG. 3, the heat pipe 202 includes a pipe 206, a cavity 208 defined in the pipe 206, a fluid 210 disposed in the cavity 208, and a wick 212. The fluid 210 transfers heat from portions of the pipe 206 that are in contact with a heat source H to portions of the pipe that are in contact with a cold object C. Specifically, the heat pipe 202 uses phase changes of the fluid 210 to transfer thermal energy from the heat source H to the cold object C. That is, the fluid 210 starts as a liquid that is heated by the heat source H and evaporates to a gas, absorbing heat from the heat source H by evaporative cooling. The gas flows through the cavity 208, forming a current. The gaseous fluid 210 flows toward the cooler portions of the pipe 206, condensing back into a liquid and releasing heat. The released heat is absorbed by the pipe 206 and the cold object C in contact with the pipe 206, which heats the cold object C. The wick 212 aids in the fluid flow by providing capillary flow for the heated fluid 210 in the liquid phase back to the heat source H. The capillary flow provided by the wick 212 allows for movement of the fluid 210 when gravity would otherwise inhibit the current. The heat pipe 202 is shown in FIG. 3 with a straight shape, and it will be appreciated that the pipe 206 and the cavity 208 may be shaped to suit specific heat transfer needs, such as an L-shape, a U-shape, an arcuate shape, or combinations thereof.

As shown in FIG. 4, the heat pipe 204 includes a pipe 206, a cavity 208 defined in the pipe 206, and a fluid 210 disposed in the cavity 208. That is, the heat pipe 204 does not include a wick 212, and the current drives the flow of the heated fluid 210 without additional capillary action. Without the wick 212, more fluid 210 may be placed in the cavity 208, increasing the current and heat transfer from the heat source H to the cold object C.

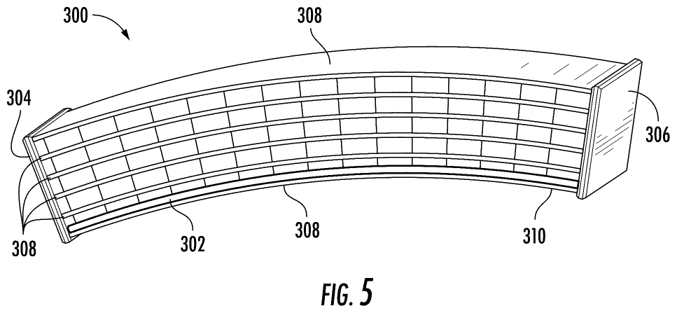

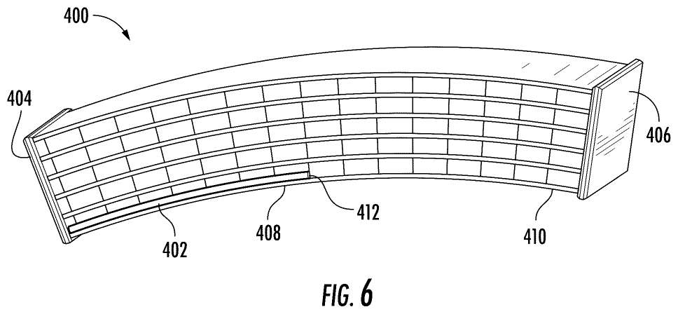

With reference to FIGS. 5-6, perspective schematic views of a heat exchanger with a heat pipe are shown. FIG. 5 shows a heat exchanger 300 with a heat pipe 302 extending between an inlet manifold 304 and an outlet manifold 306. FIG. 6 shows a heat exchanger 400 with a heat pipe 402 extending from an inlet manifold to a termination point between the inlet manifold and an outlet manifold.

Referring to FIG. 5, the heat exchanger includes the inlet manifold 304, the outlet manifold 306, and at least one plate 308 extending from the inlet manifold 304 to the outlet manifold 306. FIG. 5 shows six plates 308 extending between the inlet manifold 304 and the outlet manifold 306. The inlet manifold 304 receives a fluid (such as oil) and transmits the fluid to the plate 308. The fluid flows through channels defined in the plate 308 to the outlet manifold 306. As the fluid flows through the channels, the fluid heats the plate 308, and air passing over the plate 308 absorbs heat from the heated plate 308. When the fluid reaches the outlet manifold 306, the fluid has cooled, and the outlet manifold 306 transmits the fluid out of the heat exchanger 300.

The heat exchanger 300 includes the heat pipe 302. In the exemplary embodiment of FIG. 5, the heat pipe 302 is in thermal communication with one of the plates 308. Specifically, the heat pipe 302 extends along a leading edge 310 of a bottommost one of the plates 308 in the circumferential direction C. It will be appreciated that the heat pipe 302 may extend along any one of the plates 308.

When the fluid congeals in the plate 308, the heat pipe 302 provides heat to the plate 308 and the outlet manifold 306 to decongeal the fluid. Heated fluid may flow in the inlet manifold 304, acting as a heat source. The heat pipe 302 is in thermal communication with the inlet manifold 304, heated by the fluid, that provides heat to one end of the heat pipe 302. The fluid in the heat pipe 302 heats the remainder of the heat pipe 302, as described above. The heated heat pipe 302 provides heat to the plate 308 and the outlet manifold 306, reducing the viscosity of the fluid in the plate 308. As shown in FIG. 5, the heat pipe 302 extends between a manifold of the heat exchanger 300 to a second manifold of the heat exchanger 300, specifically, from the inlet manifold 304 to the outlet manifold 306, heating the plate along an entire circumferential length of the heat exchanger 300.

Alternatively, as shown in FIG. 6, the heat pipe 402 may extend along a leading edge 410 of a plate 408 from one manfiold of the inlet manifold 404 or the outlet manifold 406 to a termination point 412 on the plate 408 between the inlet manifold 404 and the outlet manifold 406. Rather than extending entirely along the plate 408, the heat pipe 402 may extend to the termination point 412 to heat only a portion of the plate 408. The termination point 412 may be determined based on expected locations of congealed oil in the plate 408. For example, the termination point 412 may be from 25% to 75% of the distance between the inlet manifold 404 and the outlet manifold 406. In such a form, the heat pipe 402 may be shorter in total length than the heat pipe 302 of FIG. 5.

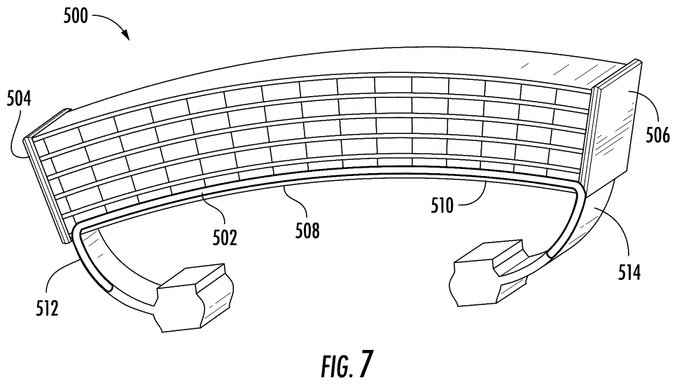

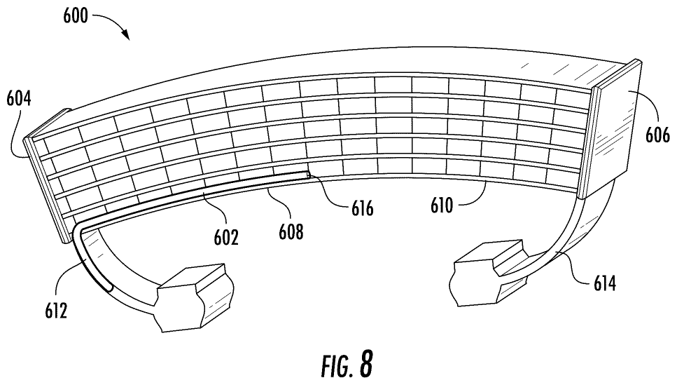

Now referring to FIGS. 7-8, perspective schematic views of a heat exchanger with a heat pipe are shown. FIG. 7 shows a heat exchanger 500 with a heat pipe 502 extending from an inlet port to an outlet port. FIG. 8 shows a heat exchanger 600 with a heat pipe 602 extending from an inlet port to a termination point on the plate between an inlet manifold and an outlet manifold.

As shown in FIG. 7, the heat exchanger 500 includes an inlet manifold 504, an outlet manifold 506, and a plurality of plates 508 extending between the inlet manifold 504 and the outlet manifold 506. The heat pipe 502 extends along a trailing edge 510 of the plate 508. The heat exchanger 500 further includes an inlet port 512 and an outlet port 514. The inlet port 512 is in fluid communication with the inlet manifold 504 to provide the inlet manifold 504 with a fluid, such as oil. The outlet port 514 is in fluid communication with the outlet manifold 506 to remove the oil from the heat exchanger 500. The heat pipe 502 extends from the inlet port 512 along the plate 508 to the outlet port 514, such that heated oil can heat the heat pipe 502 at the inlet port 512. More specifically, the heat pipe 502 extends along the trailing edge 510 of the plate 508 from the inlet port 512 to the outlet port 514. Heated oil flows into the inlet port 512 to the inlet manifold 504, heating one end of the heat pipe 502. The fluid in the heat pipe 502 transfers the heat from the heated oil to the plate 508, decongealing oil in the plate 508. Because the heat pipe 502 extends to the outlet port 514, an entire circumferential length of the plate 508 may be heated.

Alternatively, as shown in FIG. 8, the heat pipe 602 may extend from one of an inlet port 612 or an outlet port 614 to a termination point 616 on a plate 608. In FIG. 8, the heat pipe 602 extends along a trialing edge 610 of the plate 608 from the inlet port 612 to the termination point 616. As described above, the termination point 616 may be determined based on expected locations of congealed oil in the plate 608. For example, the termination point 616 may be from 25% to 75% of the distance between an inlet manifold 604 and an outlet manifold 606.

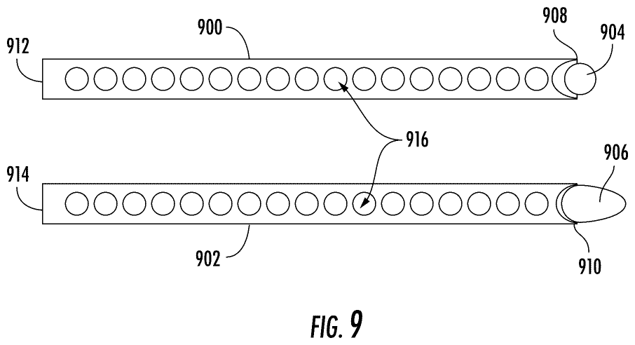

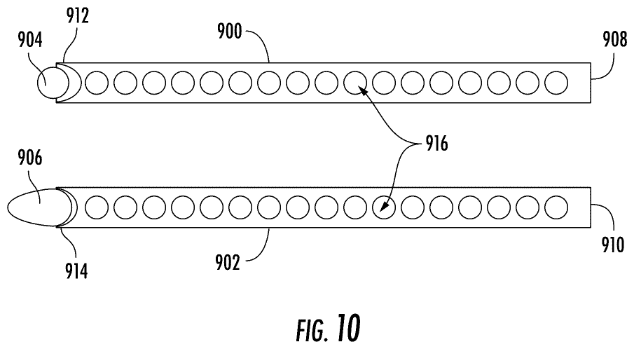

Now referring to FIGS. 9-10, cross-sectional views of two plates with a heat pipe on each plate are shown. FIG. 9 shows plates 900, 902 with heat pipes 904, 906 on leading edges 908, 910 of the plates 900, 902. FIG. 10 shows the plates 900, 902 with the heat pipes 904, 906 on trailing edges 912, 914 of the plates 900, 902.

As shown in FIG. 9, a first plate 900 has a first heat pipe 904 disposed on a leading edge 908, and a second plate 902 has a second heat pipe 906 disposed on a leading edge 910. The plates 900, 902 each define channels 916 that allow a fluid, such as oil, to flow therethrough.

Alternatively, as shown in FIG. 10, heat pipes 904, 906 may be arranged on the trailing edge 912, 914 of each of the plates 900, 902. That is, the first heat pipe 904 is disposed on the trailing edge 912, and the second heat pipe 906 is disposed on the trailing edge 914.

The heat pipes 904, 906 may have cross-sections that assist in air flow across the plate 900, 902. Specifically, the first heat pipe 904 has a circular cross-sectional shape, and the second heat pipe 906 has an aerodynamic cross-sectional shape. The first heat pipe 904 with the circular cross section may cause air flowing toward the plate 900 to become turbulent, which may improve heat transfer from the plate 900 to the air. The second heat pipe 906 with the aerodynamic cross-sectional shape allows air flowing toward the plate 902 to maintain a laminar flow, which may reduce losses in the air from turbulence. Because the air may flow toward either the leading edges 908, 910 or the trailing edges 912, 914, or both, it will be appreciated that the heat pipes 904, 906 may be arranged to provide aerodynamic assistance as specified for the heat exchanger in which the plates 900, 902 are installed. It will be appreciated that the plates 900, 902 may include heat pipes on both the leading edges 908, 910 and the trailing edges 912, 914, or different combinations thereof.

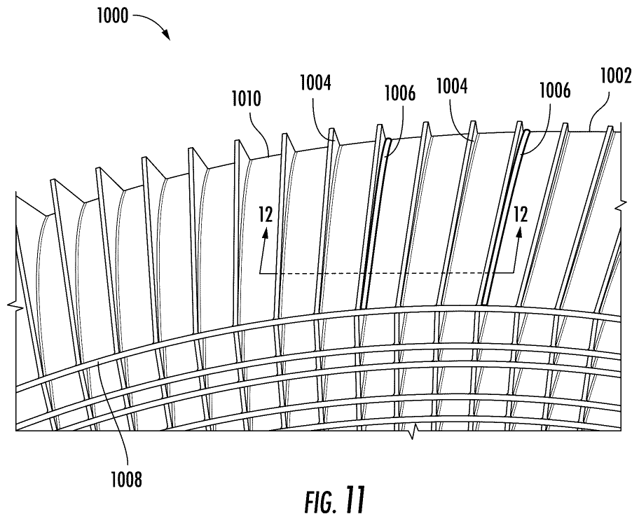

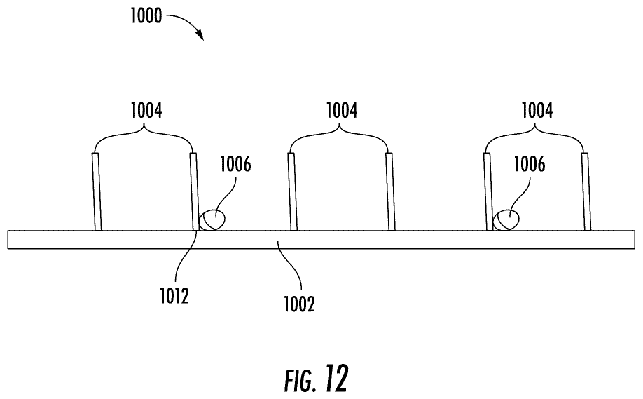

Now referring to FIGS. 11-12, views a heat exchanger 1000 are provided to illustrate heat pipe extending along fins. FIG. 11 is a perspective view of the heat exchanger 1000. FIG. 12 is a cross-sectional view of the heat exchanger 1000 along the line 12-12.

As shown in FIG. 11, the heat exchanger 1000 includes a plate 1002, a plurality of fins 1004 disposed on the plate 1002, and heat pipes 1006 extending along at least one of the fins 1004. The fins 1004 provide heat transfer from the plate 1002 to the air flowing past the plate 1002. That is, as the plate 1002 is heated by oil flowing therethrough, the fins 1004 are heated by the plate 1002. The heated fins 1004 then transfer heat to air flowing across the plate 1002, cooling the fins 1004 and the plate 1002. In the exemplary embodiment of FIG. 11, the fins 1004 extend from a leading edge 1008 of the plate to a trailing edge 1010 of the plate 1002, and it will be appreciated that the fins 1004 may extend only partially between the leading edge 1008 and the trailing edge 1010.

The heat exchanger 1000 includes at least one heat pipe 1006 that is in thermal communication with at least one of the fins 1004. As shown in FIG. 11, two heat pipes 1006 may extend from the leading edge 1008 of the plate 1002 to the trailing edge 1010 of the plate 1002, and it will be appreciated that the heat pipes 1006 may extend only partially between the leading edge 1008 and the trailing edge 101. As shown in FIG. 12, the heat pipes 1006 are each disposed at a location 1012 where the fin 1004 meets the plate 1002 such that the heat pipe 1006 is in thermal contact with both the plate 1002 and the fin 1004. The heat pipe 1006 may be secured to the fin 1004 and the plate 1002 with a thermal connection, such as a thermal adhesive, a braze, a weld, or combinations thereof. The heat exchanger 1000 may include a plurality of heat pipes 1006, each heat pipe 1006 extending along one of the fins 1004.

The heat pipe 1006 distributes heat from hot regions of the fin 1004 and the plate 1002 to colder regions of the fin 1004 and the plate 1002, reducing or inhibiting congealing of oil in the plate 1002. As an example, the trailing edge 1010 of the plate 1002 may be warmer than the leading edge 1008 of the plate 1002, and the heat pipe 1006 may transfer heat from the warmer trailing edge 1010 to the cooler leading edge 1008.

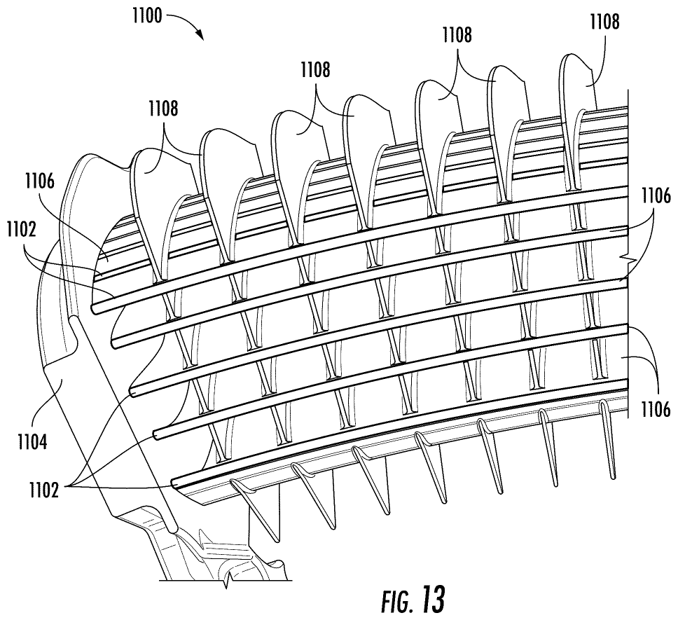

With reference to FIG. 13, a perspective view of a heat exchanger 1100 is shown. The heat exchanger 1100 includes a plurality of heat pipes 1102 extending from an inlet manifold 1104 along a plurality of plates 1106 to an outlet manifold (not shown) and beneath a plurality of fins 1108. Specifically, the heat pipes 1102 are arranged in periodic spacing along the plate 1106. That is, the plate 1106 defines a plurality of channels (not shown), and each heat pipe 1102 is arranged such that the number of channels between consecutive heat pipe is equal; this number is the “period” of the periodic spacing. For example, each heat pipe 1102 may be arranged such that there are 10 channels between consecutive heat pipes 1102, and the period would be 10. In another example, each heat pipe 1102 may be arranged such that there are 8 channels between consecutive heat pipes 1102, and the period would be 8. The periodic spacing of the heat pipes 1102 improves the uniformity of the temperature of the plates, reducing or inhibiting congealing of the oil in the plates 1106.

The heat pipes 1102 may also serve as turbulators for air flowing across the plates 1106. In this context, a “turbulator” is a structure that disrupts flow of air along the surface of the plate 1106 to increase turbulence of the air. The increased turbulence may increase the heat transfer from the plates 1106 and the fins 1108 to the air. The heat pipes 1102 may be shaped to extend out from the plate 1106 to provide a specific amount of turbulence and heat transfer, e.g., to specific Reynolds and Froude numbers determined by modeling and empirical testing. For example, the heat pipes 1102 may have circular cross-sections, elliptical cross-sections, angular cross-sections, or combinations thereof to provide the specified turbulence.

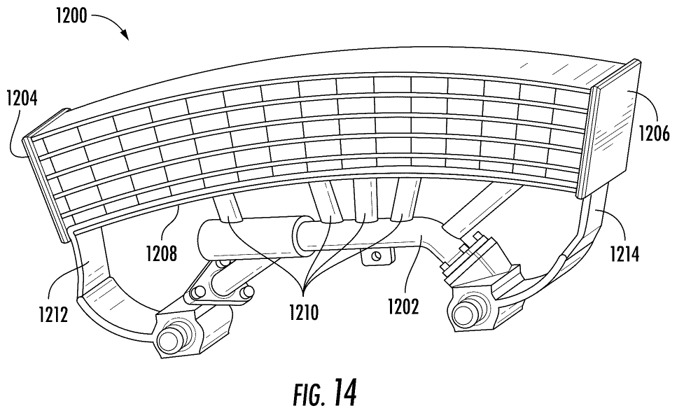

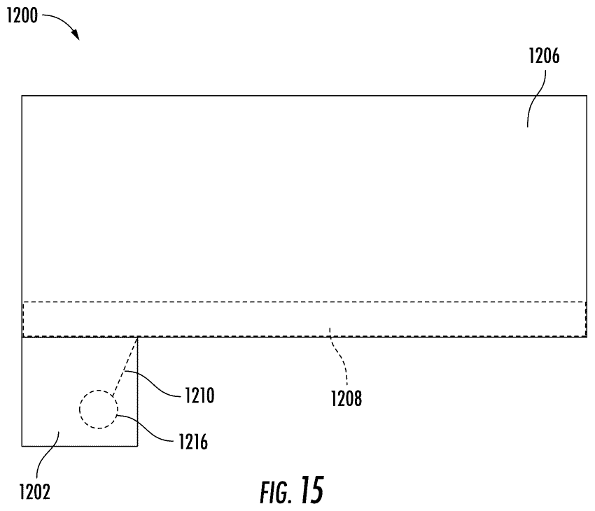

Now referring to FIGS. 14-15, a heat exchanger 1200 and a heat source 1202 are shown. FIG. 14 is a perspective view of the heat exchanger 1200. FIG. 15 is a side view of the heat exchanger 1200.

As shown in FIG. 14, the heat exchanger 1200 includes an inlet manifold 1204, an outlet manifold 1206, at least one plate 1208 extending between the inlet manifold 1204 and the outlet manifold 1206, and at least one heat pipe 1210 extending between the heat source 1202 and the plate 1208. In FIG. 14, the heat source 1202 is a bypass line. The bypass line allows oil to flow from an inlet port 1212 to an outlet port 1214 without flowing into the inlet manifold 1204 or the outlet manifold 1206. When oil is congealed in plates 1208 of the heat exchanger 1200, the bypass line allows the oil to flow unimpeded. Alternatively, the heat source 1202 may be another component that is heated during operation of the engine 100, such as a supercritical CO2 bus, a hot bleed line, among others.

The heat exchanger 1200 includes at least one heat pipe 1210 extending from the heat source 1202 to one of the plates 1208 of the heat exchanger 1200. FIG. 14 shows a plurality of heat pipes 1210 extending from the bypass line to the plates 1208. As heated oil flows through the bypass line, the heat pipes 1210 conduct the heat to the plates 1208, thereby decongealing oil in the plates 1208. The heat pipes 1210 may be disposed at specified locations on the plate 1208 to evenly distribute the heat form the bypass line, improving decongealing of the oil.

Alternatively, as shown in FIG. 15, the heat source 1202 may be a bypass plate that contacts one of the plates 1208 of the heat exchanger. A channel 1216 is defined in the bypass plate, and the heat pipes 1210 are integrated into the bypass plate. The channel 1216 allows heated oil to flow therethrough, and the heat pipes 1210 conduct the heat to the plate, thereby decongealing the oil. The bypass plate may also be heated by the heat pipes 1210, further distributing heat along the contact surface between the bypass plate and the plate 1208 of the heat exchanger 1200.

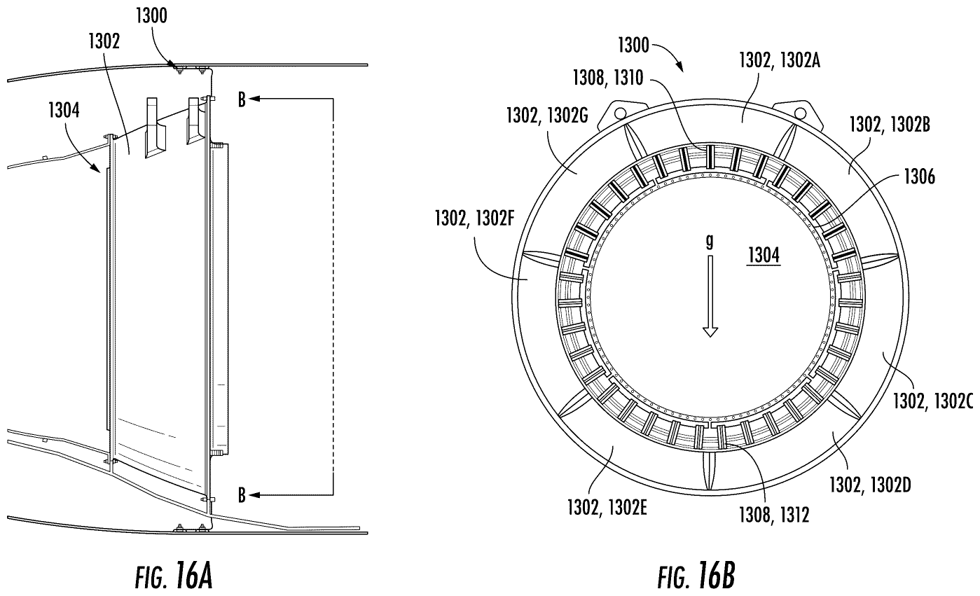

With reference to FIGS. 16A-16B, a heat exchanger assembly 1300 is shown. FIG. 16A shows a side view of the heat exchanger assembly 1300. FIG. 16B shows a rear view of the heat exchanger assembly 1300 in the directions defined by the line B-B.

The heat exchanger assembly 1300 includes a plurality of heat exchangers 1302. The plurality of heat exchangers 1302 are arranged circumferentially to form an annular shape. Specifically, the plurality of heat exchangers 1302 are arranged to extend around a fan duct 1304, as shown in FIG. 16A. The heat exchanger assembly 1300 thus assists in heat transfer for components that may be housed in the fan duct 1304.

As shown in FIG. 16B, the heat exchanger assembly 1300 includes seven heat exchangers 1302A, 1302B, 1302C, 1302D, 1302E, 1302F, 1302G (collectively, “heat exchangers 1302”). The heat exchanger assembly 1300 includes a bypass line 1306 and a plurality of heat pipes 1308 extending from the bypass line to each of the heat exchangers 1302. Each of the plurality of heat pipes 1308 may be disposed in a housing, such as a fin or a plate, that extends from the bypass line 1306 to the heat exchangers 1302. The heat pipes 1308, heated by the bypass line 1306, transmit heat to the heat exchangers 1302, decongealing oil in the heat exchangers 1302.

Because the heat pipes 1308 are arranged circumferentially, currents of some of the heat pipes 1308 may align with the direction of gravity, denoted by the label g, while currents of others of the heat pipes 1308 may oppose the direction of gravity g. As described above, the heat pipes 1308 include a fluid, such as a refrigerant, that forms a current when heated at one end of the heat pipe 1308. The current transfers heat to the other end of the heat pipe 1308, and thus the heat transfer capability of the heat pipe 1308 is affected by the speed of the current.

The heat pipes 1308 of the heat exchanger assembly include a first set 1310 of heat pipes 1308 wherein the respective currents align with the direction of gravity and a second set 1312 of heat pipes 1308 where the respective currents oppose the direction of gravity. The first set 1310 of heat pipes 1308 may be heat pipes 1308 as shown in FIG. 4, with only fluid in the respective cavities. Gravity may assist the currents in the first set 1310 of heat pipes 1308, improving heat transfer from the bypass line 1306 to the heat exchangers 1302. The second set 1312 of heat pipes 1308 may be heat pipes 1308 as shown in FIG. 3, which each include a wick. Because gravity opposes the currents of the second set 1312 of heat pipes 1308, the wicks provides capillary action that improves flow within the heat pipe 1308, increasing the currents. Alternatively, any or all of the heat pipes 1308 may or may not include a wick, and the specific combination of heat pipes 1308 may be determined based on the heat transfer specification for the heat exchanger assembly 1300.

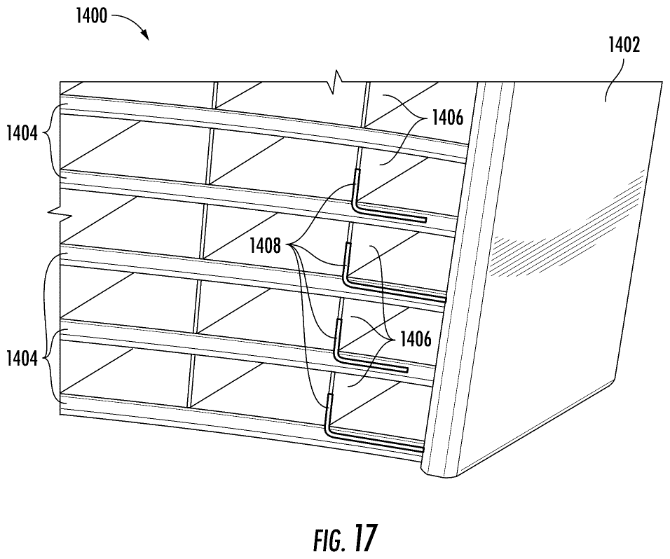

With reference to FIG. 17, a magnified view of a heat exchanger 1400 is shown. The heat exchanger 1400 includes a manifold 1402, a plurality of plates 1404 extending from the manifold 1402, at least one baffle 1406 extending between the plates 1404, and at least one heat pipe 1408. FIG. 17 shows a plurality of heat pipes 1408 and a plurality of baffles 1406. The heat pipes 1408 each extend from one of the baffles 1406 to one of the plates 1404. The heat pipes 1408 may extend to the manifold 1402. In this form, the baffles 1406 may be heated by hot air flowing through the plates 1404, and the baffles 1406 may have a higher temperature than the plates 1404 and the manifold 1402. When ice accumulates on the plates 1404 and the manifold 1402, the ice insulates the plates 1404 and the manifold 1402 from the hot air, and the baffles 1406 are heated more quickly by the hot air than the plates 1404 and the manifold 1402. The heat pipes 1408 transfer heat from the hot baffles 1406 to the cool plates 1404 and manifold 1402, heating the plates 1404 and the manifold 1402 and melting the ice that has accumulated on the plate 1404 and the manifold 1402.

Further aspects are provided by the subject matter of the following clauses:

A heat exchanger for a gas turbine engine, the heat exchanger including an inlet manifold, an outlet manifold, a plate extending from the inlet manifold to the outlet manifold, and a heat pipe in thermal communication with the plate.

The heat exchanger of any of the preceding clauses, wherein the heat pipe includes a pipe defining a cavity and a fluid disposed in the cavity.

The heat exchanger of any of the preceding clauses, wherein the heat pipe further includes a wick disposed in the cavity.

The heat exchanger of any of the preceding clauses, further including a heat source, wherein the heat pipe extends from the heat source to the plate.

The heat exchanger of any of the preceding clauses, further including a fin extending from the plate, wherein the heat pipe is in thermal communication with the fin.

The heat exchanger of any of the preceding clauses, wherein the heat pipe is in thermal contact with the fin and the plate.

The heat exchanger of any of the preceding clauses, wherein the heat pipe extends along the plate from the inlet manifold to the outlet manifold.

The heat exchanger of any of the preceding clauses, wherein the heat pipe extends along the plate from one of the inlet manifold or the outlet manifold to a termination point on the plate between the inlet manifold and the outlet manifold.

The heat exchanger of any of the preceding clauses, further including a plurality of heat pipes including the heat pipe, each of the plurality of heat pipes being in thermal communication with the plate.

The heat exchanger of any of the preceding clauses, further including a bypass line, wherein the heat pipe extends from the bypass line to the plate.

The heat exchanger of any of the preceding clauses, further including at least one baffle, wherein the heat pipe extends from the at least one baffle to the plate.

The heat exchanger of any of the preceding clauses, wherein the heat pipe has an aerodynamic cross-section.

The heat exchanger of any of the preceding clauses, further including an inlet port in fluid communication with the inlet manifold and an outlet port in fluid communication with the outlet manifold, wherein the heat pipe extends from one of the inlet port or the outlet port.

The heat exchanger of any of the preceding clauses, wherein the heat pipe extends from the one of the inlet port or the outlet port to the other of the inlet port or the outlet port.

A gas turbine engine includes a turbomachine including a compressor section, a combustion section, and a turbine section arranged in serial flow order, the turbomachine defining an engine inlet to an inlet duct, a fan duct inlet to a fan duct, and a core inlet to a core duct and a heat exchanger disposed in the fan duct, the heat exchanger including a manifold, a plate extending from the manifold, and a heat pipe in thermal communication with the plate.

The gas turbine engine of any of the preceding clauses, further including a plurality of heat exchangers including the heat exchanger, wherein the plurality of heat exchangers are arranged circumferentially around the fan duct.

The gas turbine engine of any of the preceding clauses, wherein the respective heat pipe of at least one of the plurality of heat exchangers includes a wick.

The gas turbine engine of any of the preceding clauses, wherein the heat pipe extends from the manifold.

The gas turbine engine of any of the preceding clauses, wherein the heat pipe extends from the manifold to a termination point on the plate, wherein the termination point is spaced from the manifold.

The gas turbine engine of any of the preceding clauses, further including a second manifold, wherein the heat pipe extends from the manifold to the second manifold.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A heat exchanger for a gas turbine engine, the heat exchanger comprising:
an inlet manifold;
an outlet manifold;
a plate extending from the inlet manifold to the outlet manifold; and
a heat pipe in thermal communication with the plate.

2. The heat exchanger of claim 1, wherein the heat pipe comprises a pipe defining a cavity and a fluid disposed in the cavity.

3. The heat exchanger of claim 2, wherein the heat pipe further comprises a wick disposed in the cavity.

4. The heat exchanger of claim 1, further comprising a heat source, wherein the heat pipe extends from the heat source to the plate.

5. The heat exchanger of claim 1, further comprising a fin extending from the plate, wherein the heat pipe is in thermal communication with the fin.

6. The heat exchanger of claim 5, wherein the heat pipe is in thermal contact with the fin and the plate.

7. The heat exchanger of claim 1, wherein the heat pipe extends along the plate from the inlet manifold to the outlet manifold.

8. The heat exchanger of claim 1, wherein the heat pipe extends along the plate from one of the inlet manifold or the outlet manifold to a termination point on the plate between the inlet manifold and the outlet manifold.

9. The heat exchanger of claim 1, further comprising a plurality of heat pipes including the heat pipe, each of the plurality of heat pipes being in thermal communication with the plate.

10. The heat exchanger of claim 1, further comprising a bypass line, wherein the heat pipe extends from the bypass line to the plate.

11. The heat exchanger of claim 1, further comprising at least one baffle, wherein the heat pipe extends from the at least one baffle to the plate.

12. The heat exchanger of claim 1, wherein the heat pipe has an aerodynamic cross-section.

13. The heat exchanger of claim 1, further comprising an inlet port in fluid communication with the inlet manifold and an outlet port in fluid communication with the outlet manifold, wherein the heat pipe extends from one of the inlet port or the outlet port.

14. The heat exchanger of claim 13, wherein the heat pipe extends from the one of the inlet port or the outlet port to the other of the inlet port or the outlet port.

15. A gas turbine engine comprising:
a turbomachine comprising a compressor section, a combustion section, and a turbine section arranged in serial flow order, the turbomachine defining an engine inlet to an inlet duct, a fan duct inlet to a fan duct, and a core inlet to a core duct; and
a heat exchanger disposed in the fan duct, the heat exchanger comprising a manifold, a plate extending from the manifold, and a heat pipe in thermal communication with the plate.

16. The gas turbine engine of claim 15, further comprising a plurality of heat exchangers including the heat exchanger, wherein the plurality of heat exchangers are arranged circumferentially around the fan duct.

17. The gas turbine engine of claim 16, wherein the respective heat pipe of at least one of the plurality of heat exchangers includes a wick.

18. The gas turbine engine of claim 15, wherein the heat pipe extends from the manifold.

19. The gas turbine engine of claim 18, wherein the heat pipe extends from the manifold to a termination point on the plate, wherein the termination point is spaced from the manifold.

20. The gas turbine engine of claim 18, further comprising a second manifold, wherein the heat pipe extends from the manifold to the second manifold.
